(19) United States
(12) Patent Application Publication
(10) Pub. No.: US 2011/0077957 A1
(43) Pub. Date: Mar. 31, 2011

(54) METHOD AND APPARATUS FOR INPUTTING HEALTH MANAGEMENT INFORMATION BY USING BUTTON-METHOD

(75) Inventors: Jeong-je PARK, Hwaseong-si (KR); Kwang-hyeon LEE, Seoul (KR)

(73) Assignee: Samsung Electronics Co., Ltd., Suwon-si (KR)

(21) Appl. No.: 12/841,492

(22) Filed: Jul. 22, 2010

(30) Foreign Application Priority Data
Sep. 25, 2009 (KR) 10-2009-0091152

(51) Int. Cl. G06Q 50/00; G06F 3/048

(52) U.S. Cl. 705/2; 715/840

(57) ABSTRACT

A method of inputting health management information of a user using a button-method includes: receiving a selection of at least one button from among buttons which correspond to medical events related to health management of the user; reading a current time of a clock corresponding to a point of time when the at least one button is selected; and outputting identification information and a time of selection of the selected at least one button.

### CROSS-REFERENCE TO RELATED APPLICATION

This application claims priority to Korean Patent Application No. 10-2009-0091152, filed on Sep. 25, 2009, and all the benefits accruing therefrom under 35 U.S.C. §119, the content of which in its entirety is herein incorporated by reference.

### BACKGROUND

1) Field

The following disclosure relates to a method and apparatus for inputting health management information and, more particularly, to a method and apparatus for inputting health management information using a button-method.

2) Description of the Related Art

Chronic diseases, such as diabetes and hypertension, for example, are increasing worldwide, due to various causes such as aging population, life style changes, eating habit changes and increased environmental pollution. Accordingly, the death rate from chronic diseases is also increasing. Additionally, in attempts to reduce medical expenses due to chronic diseases, home health care services that reduce visits to a hospital and/or reduce the number of days a patient is hospitalized are increasing. As such, a home tele-monitoring service has been developed for reducing medical expenses associated with medical professional, such as a physician, by remotely managing a user's disorder while the user is at a remote location, such as the user's home. When the home tele-monitoring service is used, the user, located at the remote place, transfers health management information, such as information regarding the taking of medication, to the user's medical professional. Accordingly, the medical professional can determine the health management status of the user, based on the transferred health management information, without the need to physically visit the user in the remote location.

### SUMMARY

The general inventive concept includes methods and apparatuses for conveniently and efficiently inputting health management information of a user.

The general inventive concept also includes methods and apparatuses for conveniently and efficiently managing the inputted health management information.

The general inventive concept further includes computer readable recording media having recorded thereon programs for executing the methods with the apparatuses.

Provided is a method of inputting health management information of a user by using a button-method, the method including: receiving a selection of at least one button from buttons corresponding to medical events for health management of the user; reading a current time of a clock corresponding to a point of time when the at least one button is selected; and outputting identification information and a time of selection of the selected at least one button.

Also provided is a computer program product including a computer readable computer program code for implementing the method of inputting health management information of the user by using the button-method, as well as instructions for causing a computer to implement the method.

Also provided is an apparatus for inputting health management information of a user by using a button-method, the apparatus including: a button interface including buttons corresponding to medical events related to health management of the user; a data processor that reads a current time of a clock at a point of time when at least one button of the buttons is selected by the user; and a communicator that transfers identification information and a time of selection of the selected at least one button.

Further provided is an apparatus for inputting and managing health management information of a user by using a button-method, the apparatus including: a button interface including buttons corresponding to medical events related to health management of the user; and a data processor that prepares a health management report indicating a status of the health management of the user based on a prescription by matching the prescription with identification information and a time of selection of at least one button selected by the user.

### BRIEF DESCRIPTION OF THE DRAWINGS

The above and/or other additional aspects will become more readily apparent and more readily appreciated from the following description, taken in conjunction with the accompanying drawings, in which:

FIG. 1 is a block diagram of an example embodiment of a health management system;

FIG. 2 is a block diagram of another example embodiment of a health management system;

FIG. 3 is a flowchart illustrating an example embodiment of a method of inputting and managing health management information;

FIG. 4 is a perspective view of an example embodiment of an information input device of the health management system illustrated in FIG. 1;

FIGS. 5A and 5B are perspective views of an example embodiment of an information input/management device of the health management system illustrated in FIG. 2;

FIG. 6 is a timing diagram illustrating an example embodiment of a method of inputting health information using the information input device illustrated in FIG. 4; and

FIGS. 7A through 7C are tables and corresponding timing diagrams illustrating an example embodiment of preparing a health management report using an information management device of the health management system illustrated in FIG. 1 and/or the information input/management device illustrated in FIG. 2.

### DETAILED DESCRIPTION

The general inventive concept now will be described more fully hereinafter with reference to the accompanying drawings, in which various example embodiments are shown. The invention may, however, be embodied in many different forms, and should not be construed as limited to the example embodiments set forth herein. Rather, these example embodiments are provided so that this disclosure will be thorough and complete, and will fully convey the scope of the general inventive concept to those of ordinary skill in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein but are to include deviations in shapes that result, for example, from manufacturing. For example, a region illustrated or described as flat may, typically, have rough and/or nonlinear portions. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, example embodiments of the general inventive concept will be described in further detail with reference to the accompanying drawings

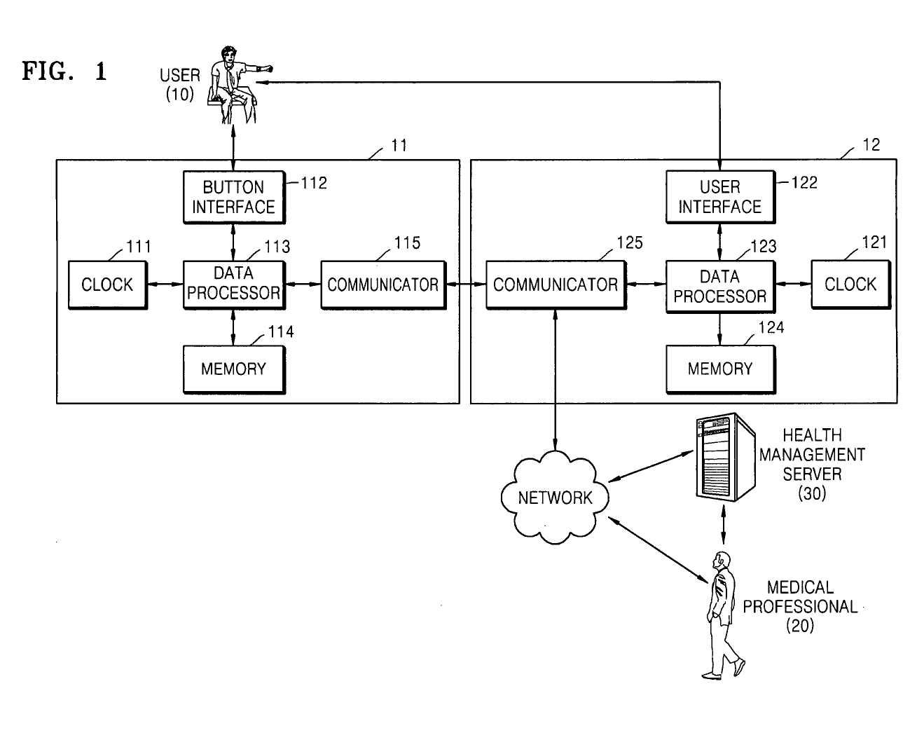

FIG. 1 is a block diagram of an example embodiment a health management system. Referring to FIG. 1, the health management system includes an information input device 11, an information management device 12 and a health management server 30. The information input device 11 and the information management device 12 communicate with each other in a peer-to-peer fashion through a wired medium or a wireless medium. The information management device 12 and the health management server 30 communicate with each other through a wired network or a wireless network. The information input device 11 and the information management device 12 may each be designed as a stand-alone device having functions that will be described in further detail below, may be installed in a user terminal or a mobile device, such as a mobile phone, for example, or may be installed in a computer at home or via a home gateway. The information input device 11 and the information management device 12 each include a power supply unit (not shown) for supplying power to the information input device 11 and the information management device 12. It will be noted that, in one or more additional embodiments, the information input device 11 and the information management device 12 may include other elements not described above.

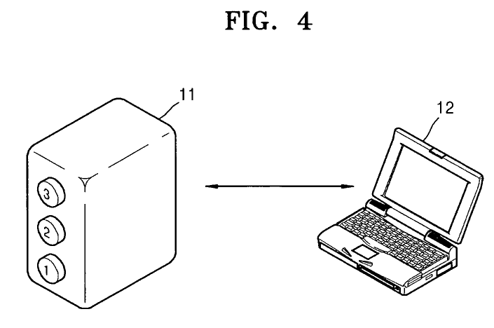

Referring to FIG. 1, the information input device 11 includes a clock 111, a button interface 112, a data processor 113, a memory 114 and a communicator 115. The clock 111 synchronizes with a clock 121 of the information management device 12, and generates a current time in uniform time units. Specifically, for example, the clock 111 may generate the current time in time units of hours, minutes and seconds, although additional embodiments are not limited thereto. The button interface 112 includes buttons (FIG. 4) corresponding to medical events related to the health management of a user 10. When the user selects at least one button from among the buttons of the button interface 112, the button interface 112 outputs a signal indicating the button or buttons selected by the user 10 to the data processor 113. For example, if the user 10 is diabetic, examples of the medical events for the health management of the user 10 may include taking medicine, such as, but not being limited to diabetes medicine (such as Metformin, commercially available as METFORMIN GR®), insulin injection for maintaining insulin levels (such as insulin detemir), and other events, such as meals, exercises and symptoms, although additional example embodiments are not limited thereto. In one or more example embodiments, the selecting of the button denotes that the user 10 has pressed the button, but the button may be selected by other methods, such as by a voice command indicating the button the user 10 wishes to select, for example.

Still referring to FIG. 1, the data processor 113 synchronizes a current time of the clock 111 with a current time received from the information management device 12 through the communicator 115, e.g., with a current time of the clock 121 of the information management device 12. More specifically, the data processor 113 may synchronize the current time of the clock 121 of the information management device 12 and the current time of the clock 111 periodically, or when the information input device 11 is turned on. In an example embodiment, the clock 121 of the information management device 12 is an internal clock of a home computer or a home gateway, and the clock 121 may therefore be accurately synchronized with a clock (not shown) of the health management server 30. Accordingly, the user 10 and a medical professional 20 have the same current time.

In an example embodiment, the data processor 113 reads the current time of the clock 111 when the user 10 selects a button of the button interface 112, e.g., when a signal indicating a button selected by the user 10 is received from the button interface 112. Accordingly, the current time of the clock 111 read by the data processor 113 corresponds to a time of selection of the button by the user 10. As such, according to the current embodiment of the present invention, the data processor 113 reads the current time of the clock 111 at the time when the user 10 selects the button, instead of the user 10 directly inputting a point of time when a medical event occurs. As a result, inaccuracies associated with inputting a point of time when a medical event occurs are effectively prevented, since no user input is required to determine the time when the user 10 selects the button.

The data processor 113 may output identification information and the time of selection of the button selected by the user 10 directly to the communicator 115 or, alternatively, may store the identification information and the time of selection in the memory 114. Also, the data processor 113 may read and output identification information and the time of selection of a button stored in the memory 114 to the communicator 115 when a request to transmit health management information is received from the information management device 12 through the communicator 115. In another example embodiment, the data processor 113 may periodically read and output the identification information and time of selection of the button stored in the memory 114 to the communicator 115. In this case, the data processor 113 may transmit a signal input from the button interface 112 as the identification information of the button selected by the user 10, or may convert and transmit the signal input from the button interface 112 as identification information of a medical event indicated by the button selected by the user 10.

The communicator 115 transmits the identification information and the time of selection of the button input from the data processor 113 to the information management device 12. As described in greater detail above, the communicator 115 may transmit the identification information and the time of selection at least one of when the button is selected by the user 10, when a request to transmit health management information is received from the information management device 12, or periodically.

Referring still to FIG. 1, the information management device 12 includes the clock 121, a user interface 122, a data processor 123, a memory 124 and a communicator 125. The clock 121 generates a current time in uniform time units, similar to as described above with reference to the clock 111. When the information management device 12 is installed in a computer at the user's home, the clock 121 may be a clock in the computer at home. The user interface 122 displays a health management report input from the data processor 123 to the user 10, receives information to be revised on the health management report from the user 10 looking at the displayed health management report, and outputs the received information to the data processor 123. More specifically, for example, the user 10 may revise a prescription, such as in a case in which the user 10 already takes a medicine similar to the medicine in the prescription (instead of taking the medicine in the prescription), or when the user 10 takes a different amount of medicine than stated in the prescription.

The data processor 123 stores a prescription received from the communicator 125 in the memory 124. Also, the data processor 123 stores the identification information and time of occurrence of a medical event input from the communicator 125 in the memory 124. The data processor 123 prepares a health management report indicating a health management status of the user 10 according to the prescription stored in the memory 124, by matching the prescription with the identification information and the time of selection of a button stored in the memory 124 for a uniform time. Specifically, the data processor 123 may determine an attribute of a medical event indicated by a button selected by the user 10 based on an order of selecting at least two buttons from among buttons respectively corresponding to medical events. As such, the data processor 123 prepares the health management report indicating the health management status of the user 10 by determining a type and attribute of a medical event indicated by a button selected by the user 10 based on identification information and the time of selection of the button selected by the user 10 from among buttons that correspond to medical events stated in the prescription stored in the memory 124, and an order of selecting the buttons.

In an example embodiment, the uniform time corresponds to a schedule for taking a medicine or injecting insulin stated in a prescription, and, more particularly, may be 12 hours or 24 hours, for example. The data processor 123 may prepare the health management report when storing of identification information and the time of selections of buttons corresponding to the schedule of the prescription in the memory 124 is completed, or when a request is received from the user 10 through the user interface 122.

Also, the data processor 123 may revise a pre-prepared health management report based on information to be revised input from the user interface 122. The data processor 123 may convert a prescription input from the communicator 125 into a format that can be displayed on the user interface 122, and output the converted prescription, since a medical professional 20, such as a physician, for example, generally issues a prescription directly to a patient, and the prescription may not necessarily be displayed on the user interface 122.

The communicator 125 receives a prescription from the medical professional 20 or the health management server 30, and outputs the prescription to the data processor 123. Also, the communicator 125 transmits a health management report received from the data processor 123 to the medical professional 20 or the health management server 30. Thus, the communicator 125 may receive a prescription from the medical professional 20 or transmit a health management report to the medical professional 20 through an email or a short message service (“SMS”) message. Also, the medical professional 20 may transmit the prescription or receive the health management report by inputting the prescription to the health management server 30 or looking at the health management report displayed on the health management server 30. As such, the medical professional 20 may determine whether the user 10 is taking a medicine according to a prescription by receiving feedback of a health management report indicating a health management status of the user 10 according to the prescription.

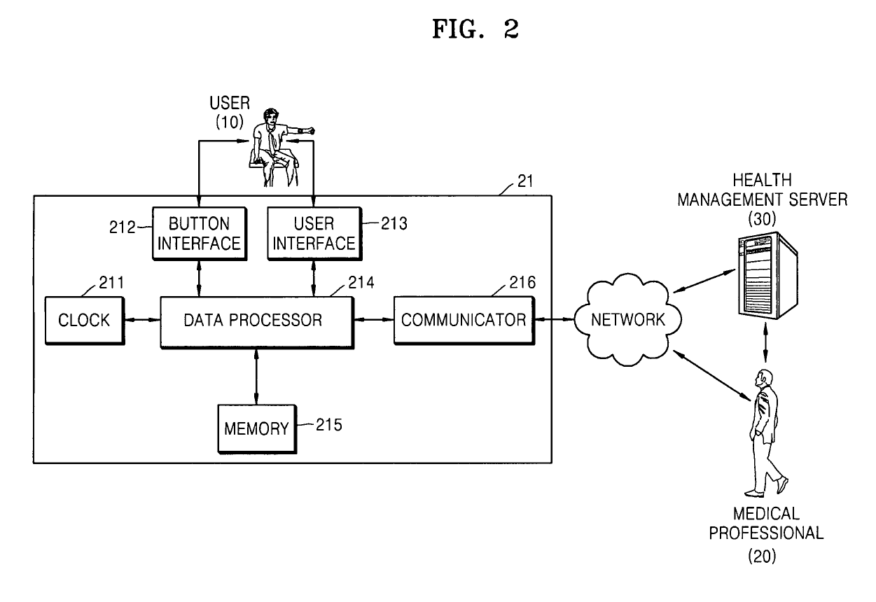

FIG. 2 is a block diagram of another example embodiment of a health management system. Referring to FIG. 2, the health management system includes an information input/management device 21 and the health management server 30. As described above with reference to FIG. 1, the information input device 11 and the information management device 12 may be designed as separate devices (as shown in FIG. 1), or, alternatively, may be designed as one device, such as the information input/management device 21 shown in FIG. 2. The information input/management device 21 and the health management server 30 communicate with each other through a wired network or a wireless network. The information input/management device 21 may be designed as a stand-alone device having functions that will be described in greater detail below, may be installed in a user terminal or a mobile device, such as a mobile phone, or may installed in a computer at a user's home or via a home gateway. The information input/management device 21 includes a power supply unit (not shown) for supplying power to the information input/management device 21. It will be noted that the information input/management device 21 according to one or more additional example embodiments may include other elements not shown in FIG. 2 or described herein.

Referring to FIG. 2, the information input/management device 21 includes a clock 211, a button interface 212, a user interface 213, a data processor 214, a memory 215 and a communicator 216. The clock 211 performs substantially the same functions as the clock 111 of the information input device 11 or the clock 121 of the information management device 12, and any repetitive detailed description thereof will hereinafter be omitted or simplified. Similarly, the button interface 212 performs substantially the same functions as the button interface 112 of the information input device 11, and the user interface 213 performs substantially the same functions as the user interface 122 of the information management device 12. Likewise, the data processor 214 performs substantially the same functions as the data processor 113 of the information input device 11 and substantially the same functions as the data processor 123 of the information management device 12, while the memory 215 performs substantially the same functions as the memory 114 of the information input device 11 and substantially the same functions as the memory 124 of the information management device 12. In an exemplary embodiment, communication function between the information input device 11 and the information management device 12 is not required, and only the communicator 216 performs a communication function with the health management server 30.

As noted above, the information input/management device 21 may perform substantially the same functions as the information input device 11 and the constitution of the information management device 12 shown in FIG. 1, and any repetitive detailed description thereof will hereinafter be omitted or simplified.

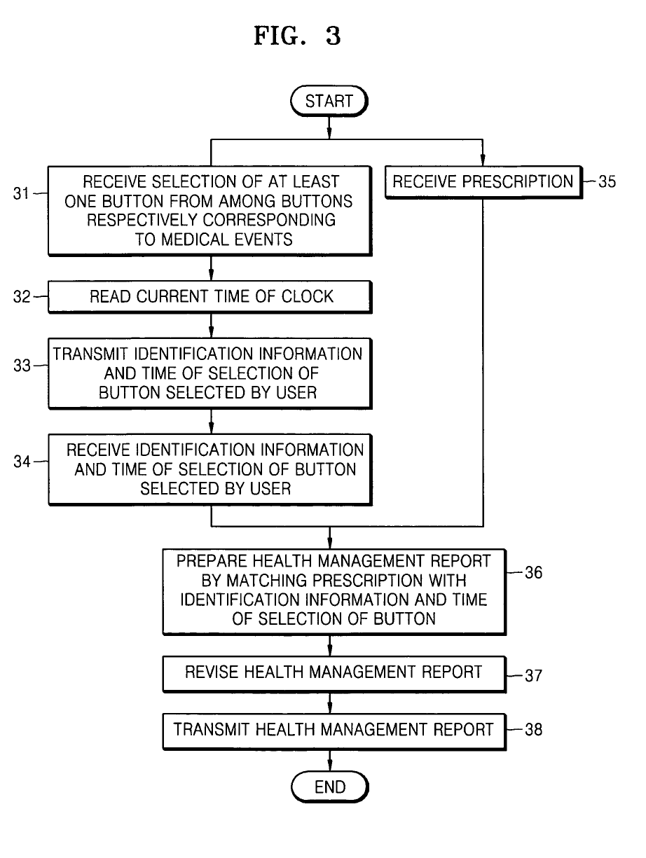

FIG. 3 is a flowchart illustrating an example embodiment of a method of inputting and managing health management information. Referring to FIG. 3, the method according to one or more example embodiments includes operations that are performed using the information input device 11 and the information management device 12, or, alternatively, the information input/management device 21. Accordingly, descriptions of the method with regard to the information input device 11 and the information management device 12 also apply to the information input/management device 21.

As shown in FIG. 3, in operation 31, the button interface 112 (FIG. 1) or 212 (FIG. 2) receives a selection of at least one button (FIG. 4) from buttons corresponding to medical events for the user 10 (FIGS. 1 and 2). In operation 32, the data processor 113 or 214 reads a current time of the clock 111 or 211 at a point in time when the at least one button is selected by the user 10, e.g., at a moment when a signal indicating the at least one button selected by the user 10 is input from the button interface 112 or 212.

In operation 33, the communicator 115 transmits identification information and the time of selection of the at least one button selected by the user 10 to the information management device 12. In operation 34, the communicator 125 receives the identification information and time of selection from the information input device 11. Since operations 33 and 34 are a communicating process between the information input device 11 (FIG. 1) and the separate information management device 12 (FIG. 1), operations 33 and 34 need not be performed in the information input/management device 21 shown in FIG. 2.

In operation 35, the communicator 125 or 216 receives a prescription from the medical professional 20 and/or the health management server 30. In operation 36, the data processor 123 or 214 prepares a health management report indicating a health management status of the user 10 according to the prescription received from the medical professional 20 or the health management server 30 by matching the prescription with identification information and the time of selections of buttons accumulated during a uniform time corresponding to a schedule of the prescription. In operation 37, when the user interface 122 or 213 receives information to be revised on the health management report prepared in operation 36, the data processor 123 or 214 revises the health management report based on the received information to be revised. In operation 38, the communicator 125 or 216 transmits the health management report prepared in operation 36 or revised in operation 37 to the medical professional 20 or the health management server 30.

FIG. 4 is a perspective view of an example embodiment of the information input device 11 illustrated in FIG. 1. Referring to FIG. 4, a total of three buttons 1, 2 and 3 are included in the button interface 112 of the information input device 11 of FIG. 1. In one or more example embodiments, the buttons are mechanical switches, on and off statuses of which are determined based on whether the user 10 presses the buttons. Also, in FIG. 4, the buttons are marked with a “1,” a “2” and a “3,” which are marks for identifying each medical event, although additional exemplary embodiments are not limited thereto, e.g., may include different marks instead of the numbers shown in FIG. 4.

In an exemplary embodiment, for example, the user 10 is informed that button 1 indicates taking of medicine (such as Metformin), button 2 indicates insulin injection (such as insulin detemir), and button 3 indicates another medical event, such as a meal, exercise or another even or medical symptom, for example. In another example embodiment button 1 may be specifically labeled “Metformin,” button 2 may be specifically labeled “Detemir” and button 3 may be specifically labeled “Meal” or “Exercise,” for example. Regardless, in the example embodiment shown in FIG. 4, when the user 10 (FIGS. 1 and 2) presses button 1 at 7:00 am, identification information and the time of selection of the button 1 corresponding to the taking of medicine, i.e. health management information that the user 10 took the medicine at 7:00 am, is transmitted from the information input device 11 to the information management device 12. As such, when at least one medical event, such as the taking of medicine, insulin injection, a meal, exercise or a symptom, for example, occurs, the user 10 inputs identification information and time of occurrence of a medical event by simply pressing a button corresponding to the medical event.

In an exemplary embodiment, the information input device 11 is a small-sized, stand-alone device that may be easily carried by the user 10, or manufactured in a wearable shape, such as in shape that is wearable a wrist of the user 10, for example. The information management device 12 (FIG. 4) may be installed in a specific- or general-use computer that is used in the user's home, for example. Accordingly, the user 10 simply presses a corresponding button on the information input device 11 attached to the user's wrist when the user 10 takes medicine, and the health management information indicating that the user 10 took the medicine is transmitted to the computer at home including the information management device 12 at the point of time when the user 10 takes the medicine.

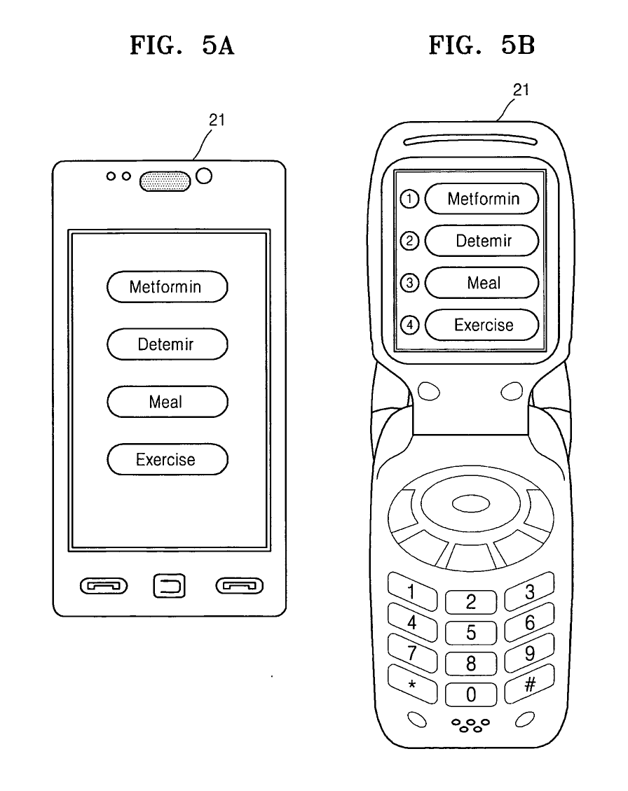

FIGS. 5A and 5B are perspective views of an example embodiment of the information input/management device 21 illustrated in FIG. 2. Referring to FIGS. 5A and 5B, the information input/management device 21 may be installed in a user terminal or a mobile device, such as in a mobile phone, for example. Specifically, FIG. 5A illustrates the information input/management device 21 implemented in a mobile phone including a touchscreen interface that performs input and output functions on one screen, while FIG. 5B illustrates the information input/management device 21 as a mobile phone including a button interface separate from the screen that performs an input function and a screen interface (disposed above the button interface in FIG. 5B) that performs an output function.

Thus, the buttons illustrated in FIG. 5A are touchscreen buttons displaying names of each medical event. Specifically, for example, the touchscreen interface of FIG. 5A displays a button for Metformin, a button for Detemir, a button for meals, and a button for exercise. Thus, the user 10 can easily and quickly identify the buttons simply by looking at the names on the buttons. Moreover, when the user 10 presses the Metformin button at 7:00 am, for example, identification information and a time of selection of the button corresponding to the user 10 taking Metformin, e.g., health management information indicating that the user 10 took Metformin at 7:00 am, is transmitted to the information management device 12 from the information input device 11.

Buttons illustrated in the lower portion of FIG. 5B are marked with marks respectively corresponding to names of each medical event displayed on the top screen interface. Thus, buttons of the mobile phone may be used as the buttons. Specifically, the top screen interface displays button 1 that corresponds to taking of Metformin, button 2 that corresponds to injecting insulin detemir, button 3 that corresponds to a meal, and button 4 that corresponds to exercise. Thus, the user 10 identifies each button simply by looking at the relationship between the numbers and the corresponding events. Thus, when the user 10 presses button 1 at 7:00 am, for example, identification information and a time of selection of button 1 corresponding to the user 10 taking Metformin, e.g., health management information indicating that the user 10 took Metformin at 7:00 am, is transmitted to the information management device 12 from the information input device 11.

Thus, in the example embodiments described herein, the user 10 easily determines which button indicates which medical event, without needing to be notified of a relationship between the buttons of the information input/management device 21 and medical events. Moreover, the marks corresponding to the buttons displayed on the touchscreen interface of FIG. 5A or the top screen interface of FIG. 5B are easily changed according to the contents of a prescription or an intention/desire of the user 10.

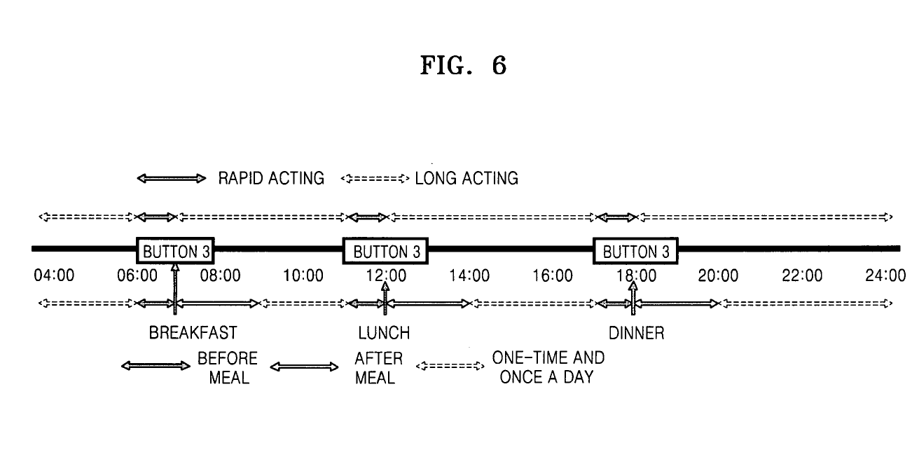

FIG. 6 is a timing diagram for describing an example embodiment for inputting of health information by using the information input device 11 illustrated in FIG. 4. For purposes of discussion of FIG. 6, it will hereinafter be assumed that the user 10 is informed that button 1 indicates taking Metformin, button 2 indicates injecting insulin detemir, and button 3 indicates a meal. Referring to FIG. 6, it can be seen that the user 10 pressed button 3 at 7:00 am (midway between 06:00 and 08:00), 12:00 pm (12:00) and 6:00 pm (18:00). This indicates that the user 10 had a meal at 7:00 am, 12:00 pm and 6:00 pm. When button 1 is pressed within one hour before button 3 is pressed, the data processor 123 or 214 determines that Metformin was taken before the corresponding meal. Additionally or in contrast, when button 1 is pressed within 2 hours after button 3 is pressed, the data processor 123 or 214 determines that Metformin was taken after the meal corresponding meal. On the other hand, when button 1 is pressed at other than the above-mentioned times, the data processor 123 or 214 determines that a one-time medicine or a once-a-day medicine has been taken. Additionally, when button 3 is pressed at yet another point of time, such as aside from between 6:30 am and 7:30 am, between 11:30 am and 12:30 pm and between 5:30 pm and 6:30 pm, which may be predetermined as general meal times, the data processor 123 or 214 may determine that the user 10 has performed exercise, instead of eating a meal.

Generally, insulin is classified as rapid-acting insulin or long-acting insulin. Moreover, the rapid-acting insulin can be generally injected within 30 minutes before a meal. Accordingly, when button 2 is pressed within 30 minutes before button 3 is pressed, for example, the data processor 123 or 214 determines that rapid-acting insulin has been injected. When button 2 is pressed at other times, however, the data processor 123 or 214 determines that the long-acting insulin has been injected.

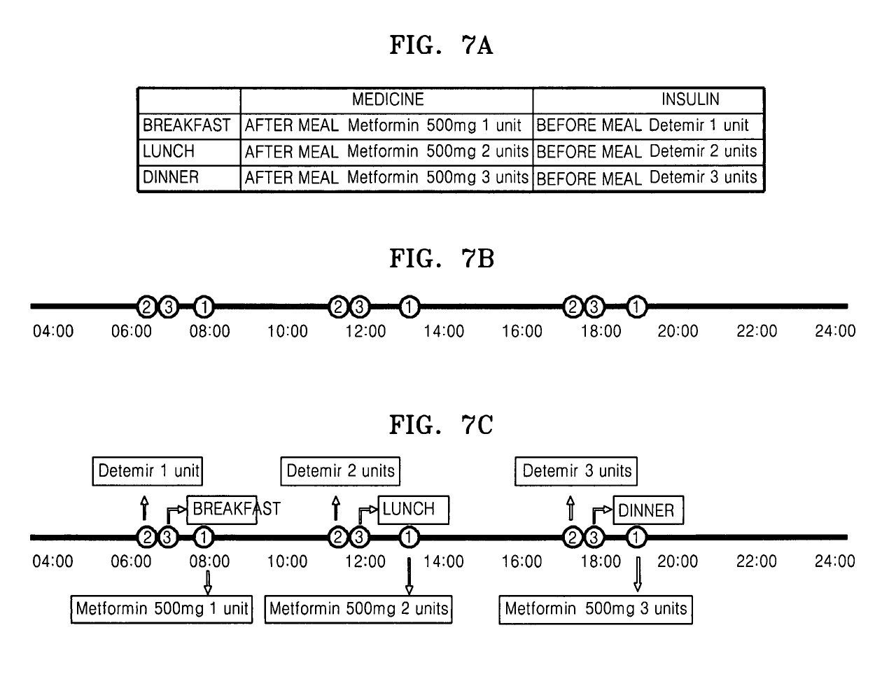

FIGS. 7A through 7C are tables and corresponding timing diagrams for describing in further detail an example embodiment of preparing a health management report using the information management device 12 of FIG. 1 and/or the information input/management device 21 of FIG. 2. Specifically, FIG. 7A illustrates a prescription, in table form, that the medical professional 20 has issued to the user 10. FIG. 7B illustrates time records of medical events inputted by the user 10 using the button-method. FIG. 7C illustrates a health management report prepared by matching the prescription of FIG. 7A with identification information and the time of selection of buttons illustrated in FIG. 7B.

A shown in FIG. 7B, it can be seen that the user 10: pressed button 1 at 8:00 am (08:00), 1:00 pm (13:00) and 7:00 pm (19:00); pressed button 2 at 6:40 am (06:40), 11:40 am (11:40) and 5:40 pm (17:40); and pressed button 3 at 7:00 am (07:00), 12:00 pm (12:00) and 6:00 pm (18:00). The information management device 12 or the information input/management device 21 prepares the health management report, shown in FIG. 7C, by determining, based on the above-listed button pushes, that one unit of Determir was injected before breakfast, one unit of Metformin was taken after breakfast, two units of Detemir were injected before lunch, two units of Metformin were taken after lunch, three units of Detemir were injected before dinner and three units of Metformin were taken after dinner, as corresponds to the prescription information shown in FIG. 7A.

In a conventional health management system, it is very inefficient and inconvenient for a user to directly input various pieces of information, such as names of medicine, units of medicine taken and times of taking the medicines. However, according to the example embodiments of the health management system described herein, a health management report indicating a health management status of the user according to a prescription is automatically prepared as the user simply presses buttons corresponding to medical events, such as the taking of medicine. Accordingly, the user conveniently, efficiently and accurately inputs health management information.

The example embodiments of the general inventive concept can be written as computer programs and can be implemented in specific- or general-use digital computers that execute the programs using a computer readable recording medium. Also, the structure of data used in the embodiments may be recorded on the computer readable recording medium by using various methods. Examples of the computer readable recording medium include, but are not limited to, magnetic storage media, e.g., read-only memory (“ROM”), floppy disks and hard disks, as well as optical recording media, such as compact disc read-only memory (“CD-ROM”) and digital versatile disc (“DVD”), for example.

The general inventive concept should not be construed as being limited to the example embodiments set forth herein. Rather, these example embodiments are provided so that this disclosure will be thorough and complete and will fully convey the concept of the present invention to those of ordinary skill in the art.

Additionally, while the general inventive concept has been particularly shown and described with reference to example embodiments thereof, it will be understood by those of ordinary skill in the art that various changes in form and details may be made therein without departing from the spirit or scope of the general inventive concept as defined by the following claims.

What is claimed is:

1. A method of inputting health management information of a user using a button-method, the method comprising:
receiving a selection of at least one button from buttons which correspond to medical events related to health management of the user;
reading a current time of a clock corresponding to a point of time when the at least one button is selected; and
outputting identification information and a time of selection of the selected at least one button.

2. The method of claim 1, wherein each of the buttons includes a mark respectively corresponding to each of the medical events.

3. The method of claim 1, further comprising preparing a health management report indicating a status of the health management of the user based on a prescription by matching the prescription with identification information and the point of time when the at least one button is selected.

4. The method of claim 3, wherein the preparing the health management report comprises determining a type and attribute of a medical event indicated by the selected at least one button based on the identification information and the point of time corresponding to medical events prescribed in the prescription and an order of selecting the at least one button.

5. The method of claim 3, further comprising, upon receiving information to be revised on the health management report, revising the health management report based on the received information to be revised.

6. The method of claim 1, further comprising synchronizing a current time received from an external source with the current time of the clock.

7. A computer program product comprising:
a computer readable computer program code for implementing a method of inputting health management information of a user by using a button-method; and
instructions for causing a computer to implement the method, the method comprising:
receiving a selection of at least one button from buttons which correspond to medical events related to health management of the user;
reading a current time of a clock corresponding to a point of time when the at least one button is selected; and
outputting identification information and a time of selection of the selected at least one button.

8. An apparatus for inputting health management information of a user by using a button-method, the apparatus comprising:
a button interface including buttons which correspond to medical events related to health management of the user;
a data processor which reads a current time of a clock at a point of time when at least one button of the buttons is selected by the user; and
a communicator which transfers identification information and a time of selection of the selected at least one button.

9. The apparatus of claim 8, wherein each of the buttons includes a mark respectively corresponding to each of the medical events.

10. The apparatus of claim 9, wherein the mark comprises at least one of a number and a character.

11. The apparatus of claim 9, wherein the buttons touchscreen buttons which display a name corresponding to each of the medical events.

12. The apparatus of claim 9, wherein the marks correspond to names of each of the medical events, the names being displayed on a screen.

13. An apparatus for inputting and managing health management information of a user by using a button-method, the apparatus comprising:
a button interface including buttons which correspond to medical events related to health management of the user; and
a data processor which prepares a health management report indicating a status of the health management of the user based on a prescription by matching the prescription with identification information and a time of selection of at least one button selected by the user.

14. The apparatus of claim 13, wherein the data processor determines attributes of the medical events based on at least two buttons selected from the buttons based on an order of selecting the at least two buttons.

15. The apparatus of claim 14, wherein the data processor prepares the health management report indicating the status of the health management by determining a type and attribute of a medical event indicated by the selected at least one button based on the identification information and a point of time of selection of the at least one button corresponding to medical events prescribed in the prescription and an order of selecting the at least one button.

16. The apparatus of claim 14, wherein
the medical events comprise taking medicine and consuming a meal, and
the data processor determines whether the taking of the medicine is before or after the consuming the meal based on an order of selecting a button corresponding to the taking of medicine and a button corresponding to the meal.

17. The apparatus of claim 14, wherein the medical events comprise an insulin injection and consuming a meal, and
the data processor determines whether the insulin is rapid-acting insulin or long-acting insulin based on an order of selecting a button corresponding to the insulin injection and a button corresponding to consuming the meal.
